(19) United States
(12) Patent Application Publication
(10) Pub. No.: US 2012/0036816 A1
(43) Pub. Date: Feb. 16, 2012

(54) Horse Eye Protection Device

(76) Inventor: Amanda Rachelle Gilligan, Tucson, AZ (US)

(21) Appl. No.: 12/853,591

(22) Filed: Aug. 10, 2010

(51) Int. Cl. B68C 5/00

(52) U.S. Cl. 54/80.2

(57) ABSTRACT

A horse eye protection device is provided with a mask including a multiplicity of pairs of interchangeable lenses. The lenses may be made of a durable, shatterproof material. The lenses may be a clear transparent lens, a tinted transparent lens, a blackout lens, or a blinder lens. These lenses help protect against wind, insects, debris and ultraviolet exposure, as well as assisting the eye in healing from infection and acting as a blinder to prevent distraction of the horse.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to a protective mask for assisting the eyes of an animal heal from injury or infection, as well as protecting the eyes from wind, insects, debris and the sun. More particularly, the present invention relates to a device designed to protect the eyes of a horse with protective lenses which may be adapted to be used as black-out lenses, transparent protective lenses or UV-protective lenses.

2. Description of the Related Art

Several hazards pose threats to a horse's eye. Insects, sticks, hay and airborne debris can injure the eye of a horse if the cornea becomes scratched or otherwise damaged. Injured eyes can become infected and require further treatment. During treatment, which often requires the eye to be dilated, the eye must be completely shielded from light and protected to prevent further damage and to allow the eye an opportunity to heal properly.

Another hazard exists in exposure to ultraviolet light. Exposure to ultraviolet may result from extended or frequent sun exposure, or high altitude conditions. This exposure has been known to cause sunburn, cataracts and even cancer within a horse's eye.

Attempts to address some of these hazards exist. A traditional fly mask provides protection from insects and minimal protection from ultraviolet light. These masks provide their protection at the expense of clear vision for the horse.

Alternatively, masks are made with a hard plastic piece in place which may act as a blackout lens during the healing period after an injury to the eye.

Blinders, or blinkers, are also made to obstruct part of the horse's field of vision. By obstructing part of the field of vision, the horse is not distracted by movement within the obstructed portion of the field of vision.

Each of these masks are made to be single-purposed. If environmental conditions such as lighting or the work performed by the horse requires a change from one mask to another, a person must first remove the mask the horse is wearing, select a stowed mask appropriate for the conditions, then place the selected mask on the horse. Prior solutions do not allow a person to quickly change which mask a horse is wearing, and the individual masks do not provide complete protection for multiple types of hazards.

A solution is needed to address one or more of these shortcomings in the prior art.

### BRIEF SUMMARY OF THE INVENTION

The horse eye protection device utilizes a mask which wraps around the horse's head. The mask is made from a breathable and stretchable fabric, such as a cotton/polyester/spandex knit. The mask is stretchable, so that it may stretch around the horse's head, yet durable enough to maintain its general form. The mask is placed over the horse's head and is closed by means of a zipper placed from the horse's throat to the jaw.

Holes are placed in the mask around the horse's eyes and ears. In the interior of the mask, around the eye holes, are foam or cotton cushions which rest upon the face of the horse, and are attached to the mask. Above the cushion, on the exterior of the mask, are several snaps which may be used to connect the various lenses to the mask.

Various pairs of lenses are provided for the mask. These lenses are constructed from a durable, shatterproof plastic. Lenses are domed with an attached flange. The flanges have snaps paired with the snaps on the mask. Lens pairs may be completely transparent for protection against wind and debris, tinted for protection against ultraviolet light, a blackout lens to completely shield the eye, or partially transparent and partially opaque for use as a blinder.

Use of the eye protection device allows a horse handler to quickly and easily change which lenses are applied to the horse's mask, without need of removing the mask or carrying multiple masks.

### BRIEF DESCRIPTION OF THE SEVERAL VIEWS OF THE DRAWING

FIG. 1 depicts a lateral view of a horse wearing a horse eye protection device.

FIG. 2 depicts a detail view of a lens 16 of a horse eye protection device.

FIG. 3 depicts a cross-sectional view of a lens 16 of a horse eye protection device.

### DETAILED DESCRIPTION OF THE INVENTION

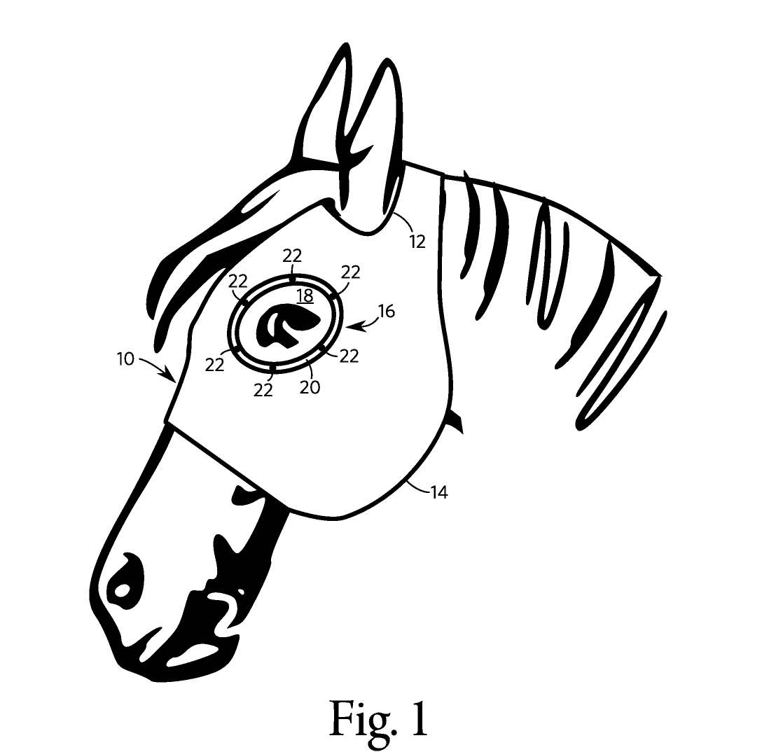

Referring to FIG. 1, the horse eye protection device utilizes a protective mask 10 which may be placed over the head of a horse. The mask extends from the top of the head to the top of the jaw, with ear holes 12 allowing the ears of the horse to pass through the protective mask 10. The protective mask 10 is secured on the head of the horse by means of a zipper 14, which extends along the bottom of the mask from the throat of the horse to the jaw of the horse. The zipper may be fixed by a safety clasp.

The protective mask 10 should be constructed from a breathable and stretchable material. While other materials may be used, a cotton/polyester/spandex blend may be used to provide a material that is both breathable and stretchable. The material should have enough elasticity to allow the protective mask 10 to accommodate the shape of the head, yet be sturdy enough to maintain its general form.

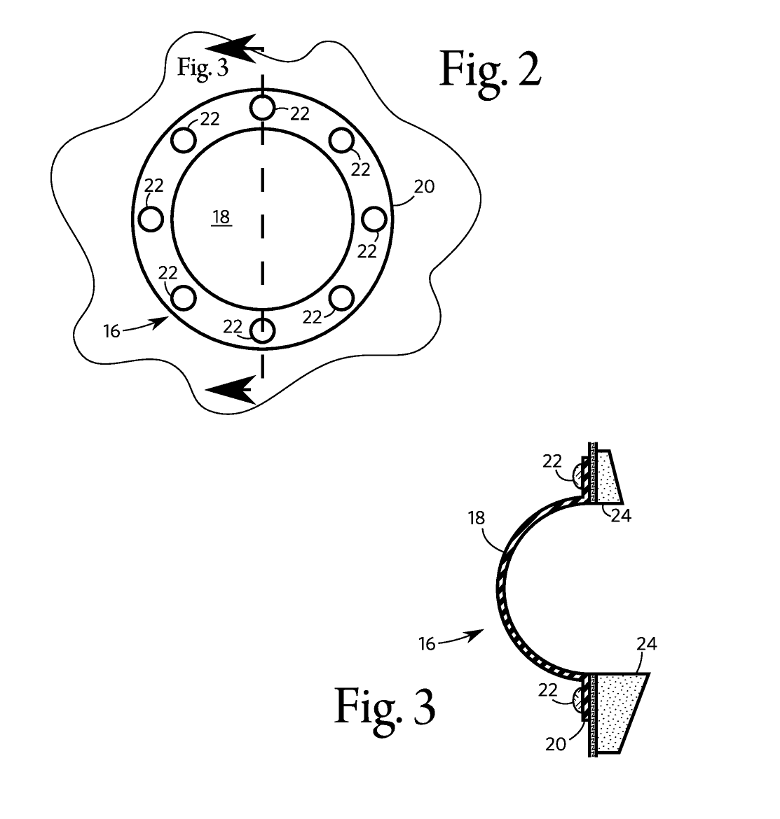

Referring now to FIGS. 2 and 3, the protective mask 10 has eye holes fitted with interchangeable lenses 16. Each lens 16 is constructed from a durable, shatterproof plastic. Each lens 16 has a curved dome 18. The dome 18 is made as a 3.5 inch (8.9 cm) diameter hemisphere, approximately 0.125 inch (3.2 mm) thick. Extending outward from the dome 18 is a flange 20. The flange 20 is integrally formed with the dome 18. The flange 20 is approximately 0.75 inch (1.9 cm) to 1 inch (2.5 cm) wide. The flange 20 should be somewhat flexible to allow it to conform to the shape of the protective mask 10 as it rests on the head of the horse. The flange 20 holds a multiplicity of snaps 22, typically six to eight spaced around the flange 20. One portion of the snaps 22 may be embedded in the flange 20 or adhered to the bottom of the flange 20. The other portion of the snaps 22 is attached to the protective mask 10. The snaps 22 allow a handler to attach a lens 16 to the protective mask 10.

On the interior of the protective mask 10 is a cushion 24. The cushion 24 is attached to the interior of the protective mask 10 under the flange 20. The cushion 24 rests around the eye of the horse, providing padding between the protective mask 10 and the face of the horse. The cushion 24 is substantially conical in shape, the cushion 24 being thinner toward the brow of the horse, and thicker toward the bottom of the mask.

A horse eye protection device has multiple pairs of interchangeable lenses 16. A clear transparent lens 16 may be provided for protection against wind and debris. A tinted transparent lens 16 may be provided for protection against ultraviolet light, as well as wind and debris. The tinted transparent lens 16 may reduce the amount of harm due to ultraviolet exposure, and thus help prevent cancer in the eye of the horse. A blackout lens 16 may be provided for use during healing of an eye injury. A blinder lens 16 may be provided, wherein a portion of the lens 16 is opaque and another portion of the lens 16 is transparent, either clear or tinted.

Having a multiplicity of lenses 16 allows a horse handler to quickly and easily change which lens 16 placed on the protective mask 10. For example, changes in environmental conditions, such as changes in lighting, may require a handler to change from a tinted transparent lens 16 to a clear transparent lens 16, or vice versa. Likewise, changes in the work a horse is performing may require a change from a transparent lens 16 to a blinder lens 16, or vice versa. Changing from one lens 16 to another may be done by unsnapping the snaps 22 one one lens and attaching another lens 16 by the snaps 22.

I claim:

1. An eye protection device for an animal, the device comprising:
(A) a mask for placing over the head of the animal; and
(B) a multiplicity of pairs interchangeable lenses, the lenses comprising
(i) a central domed portion, and
(ii) means for attaching the lens to the mask.

2. The eye protection device of claim 1 wherein the central domed portion is constructed from a durable, shatterproof material.

3. The eye protection device of claim 2 wherein the interchangeable lenses are clear transparent, tinted transparent, blacked out, or partially transparent and partially opaque.

4. The eye protection device of claim 3 wherein the interchangeable lenses further comprise a flange extending out from the central domed portion and the means for attaching the lens to the mask is two or more snaps attached to both the flange and the mask.

5. An eye protection device for an animal, the device comprising:
(A) a mask for placing over the head of the animal; and
(B) a multiplicity of pairs interchangeable lenses, the lenses comprising
(i) a central domed portion, the central domed portion constructed from a durable, shatterproof material,
(ii) a flange extending out from the central domed portion, and
(iii) at least two snaps for attaching the lens to the mask.
